(19) United States
(12) Patent Application Publication
(10) Pub. No.: US 2002/0117353 A1
(43) Pub. Date: Aug. 29, 2002

(54) Adjustable safety line

(76) Inventor: D. Keith Jones, Huntsville, AL (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 09/954,838

(22) Filed: Sep. 12, 2001

Related U.S. Application Data
(60) Provisional application No. 60/232,585, filed on Sep. 14, 2000.
(60) Provisional application No. 60/264,036, filed on Jan. 25, 2001.

(51) Int. Cl. A62B 1/16

(52) U.S. Cl. 182/3

(57) ABSTRACT

A safety line and method of use for minimizing the risk of injury due to a fall from an elevated position. A slidable loop on a standing line is coupled to the user to permit adjustment of the effective length of the safety line during use. The safety line serves double duty as a lineman's belt and also can be configured to function as a deer drag.

### CROSS REFERENCE TO RELATED APPLICATIONS

This application claims the priority benefit of U.S. Patent Application Serial Nos. 60/232,585, filed Sept. 14, 2000, and 60/264,036, filed Jan. 25, 2001 which are hereby incorporated by reference in its entirety.

### BACKGROUND OF THE INVENTION

1. Field of the Invention

The present invention relates generally to safety equipment and methods, and more particularly to a safety line and method of use thereof for preventing injury from falls from elevated positions and during climbing and descending.

2. Description of Related Art

Many activities require a participant to take an elevated position above the ground, and to climb and descend to and from that elevated position. For example, hunters, wildlife photographers and other sportsmen often position themselves in elevated tree stands many feet above the ground. Linesmen and maintenance workers also must access elevated equipment for repair and installation purposes. These activities present the risk of injury if the participant falls from an elevated position above the ground.

Various safety practices and equipment have been developed to reduce the risk of injury from falls during elevated activities. For example, a variety of safety belts and harnesses are known. These devices typically engage portions of the wearer's body and permit the wearer to attach a safety line between the harness or belt and some elevated structure. In the event of a fall, the wearer will not fall to the ground, but instead will only fall as far as the safety line's length will permit. Thus, a shorter safety line generally reduces the distance the wearer can fall, and the resulting impact on user. Depending on the activity, however, it is often desirable or necessary that the length of the safety line be greater than would provide the maximum degree of safety in the event of a fall. For example, when standing on a tree stand, the user may wish to tie the safety line to the tree at or above head level, and use a relatively taut safety line to minimize the distance of any fall. However, a safety line configured in this manner restricts the user's ability to then sit down on the tree stand or to bend down to tie a shoe or retrieve equipment. As a result, it may be necessary for the user to periodically loosen, untie, or disconnect the safety line for repositioning. When the safety line is loosened or untied, the user is at increased risk in the event of a fall.

Accordingly, it has been found that a need exists for a safety line and method of use that permit a user to readily and safely adjust the effective length of a safety line during use. It is to the provision of a safety line and method meeting these and other needs that the present invention is primarily directed.

### SUMMARY OF THE INVENTION

The present invention provides an improved safety line, a safety system for preventing injury from a fall, and a method for preventing injury due to a fall from an elevated position. The user can adjust the effective length of the safety line during use, without untying or loosening the line from the support structure. This permits the user to configure the safety line for minimum effective length during normal use in order to minimize the distance of any fall, and to safely and easily reconfigure the safety line to a longer effective length when greater freedom of movement is required.

In one aspect, the invention is a safety line including a standing line having means for attachment to a support structure. The safety line preferably also includes a sliding loop connected to the standing line and slidable along at least a portion of the length of the standing line, wherein the sliding loop is freely movable along the standing line when not loaded, but resists movement relative to the standing line when under load.

In further preferred embodiments, the sliding loop comprises a prusik knot or hitch tied to the standing line.

In another aspect, the invention is safety system for preventing injury from a fall. The safety system preferably includes a safety harness for engaging a wearer; a standing line for attachment to a support structure; a sliding loop slidable along at least a portion of the length of the standing line, wherein the sliding loop is freely movable along the standing line when not loaded, but resists movement relative to the standing line when under load; and coupling means for attaching the sliding loop to the safety harness.

In another aspect, the invention is method for preventing injury due to a fall from an elevated position. The method of the present invention preferably entails securing a standing line to a support structure adjacent the elevated position. A sliding loop is slidably connected to the standing line, whereby the sliding loop is freely movable along the standing line when not loaded, but resists movement relative to the standing line when under load. The sliding loop is preferably coupled to a user to prevent injury from a fall.

In a particularly preferred embodiment, the sliding loop is a prusik knot or hitch. In yet another particularly preferred embodiment, the sliding loop is coupled to a harness worn by the user.

These and other features and advantages of the present invention are described herein with reference to example embodiments shown in the appended drawing figures.

### BRIEF DESCRIPTION OF THE DRAWING FIGURES

FIG. 1 is an elevational view of a person using the safety line of the present invention according to a preferred form of the present invention.

FIG. 2 is a detailed view of a portion of the safety line of the present invention according to a preferred form.

FIGS. 3a-3f schematically depict the tying of a looped knot portion of the safety line of the present invention according to a preferred form.

### DETAILED DESCRIPTION

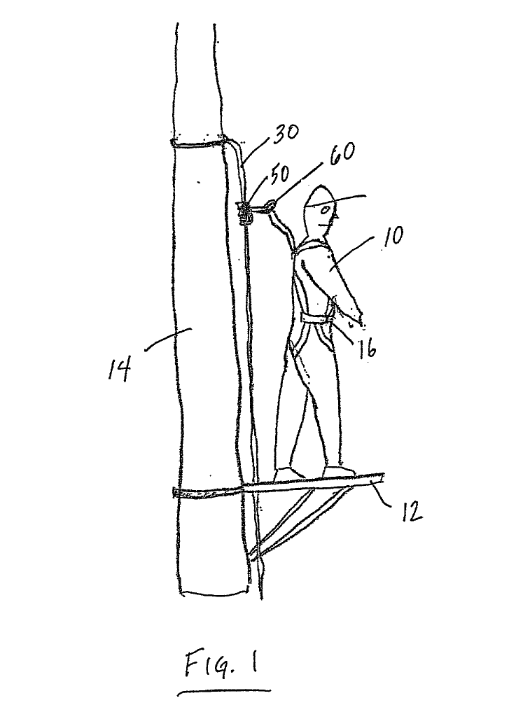

Referring now to the drawing figures, wherein like reference numerals represent like parts throughout, preferred forms of the present invention will now be described. FIG. 1 shows an elevated user 10 standing on a tree stand 12, which is mounted to a support structure such as a tree 14. The user 10 preferably wears a harness 16, such as a safety belt or a multi-point body harness. The tree stand 12 can be permanently mounted to the support structure, or can be a climbing-type tree stand. Although a tree stand is depicted in the figures and described in the example embodiments disclosed herein, it will be understood that the present invention can readily be adapted for use in connection with tree stands, elevated platforms, and virtually any other elevated structures.

A standing line 30 is attached to the tree 14 or other support structure, preferably at a location above the expected elevated position of the user. The standing line 30 is preferably a length of rope of sufficient strength to support the user and to withstand an impact load of the user's weight falling from a height at least equal to the length of the standing line 30. In a particularly preferred embodiment, the standing line 30 comprises 4,000 pound test polyester rope, and has a length of about 30 feet, more preferably about 10 feet. As seen best with reference to FIG. 2, the standing line preferably comprises means for attachment to the support structure, such as a looped portion 32 of the standing line 30, or a clip such as a carabiner or D-ring secured to the standing line 30. In the example embodiment depicted by the figures, a fixed loop 32 such as a bowline knot, is tied in a first end of the standing line 30, the standing line is wrapped around the support structure 14, the second end of the standing line is passed through the loop 32, and the standing line is cinched about the support structure with a free end hanging downwardly.

The present invention preferably further comprises a sliding loop 50 connected to the standing line 30, as seen best with reference to FIG. 2. The sliding loop 50 is preferably slidable along at least a portion of the length of the standing line 30, and is freely movable along the standing line 30 when not loaded, but resists movement relative to the standing line when under load. In this manner, the user can freely adjust the position of the sliding loop 50 along the standing line 30 during normal use, without the need for loosening or untying the safety line. In the event of a fall, however, the user's weight applies load to the sliding loop 50, preventing the sliding loop from sliding along the standing line 30. In a preferred embodiment of the invention depicted in the figures, the sliding loop 50 is preferably a knotted length of rope. In alternate embodiments, the sliding loop may comprise a mechanical, electromechanical or magnetic device permitting movement along the standing line 30 when unloaded, but resisting movement relative to the standing line when under load. The rope forming the sliding loop 50 is preferably of a somewhat smaller diameter than the standing line 30. For example, the sliding loop 50 can comprise a length of 3,000 pound test polyester rope. In a particularly preferred embodiment of the invention, the sliding loop 50 comprises a length of rope tied into a Prusik knot. In alternate embodiments, other sliding loop knots, such as for example, a Kleimheist knot, a Blake's hitch, or a Kreutzklem knot may be used to form the sliding loop 50.

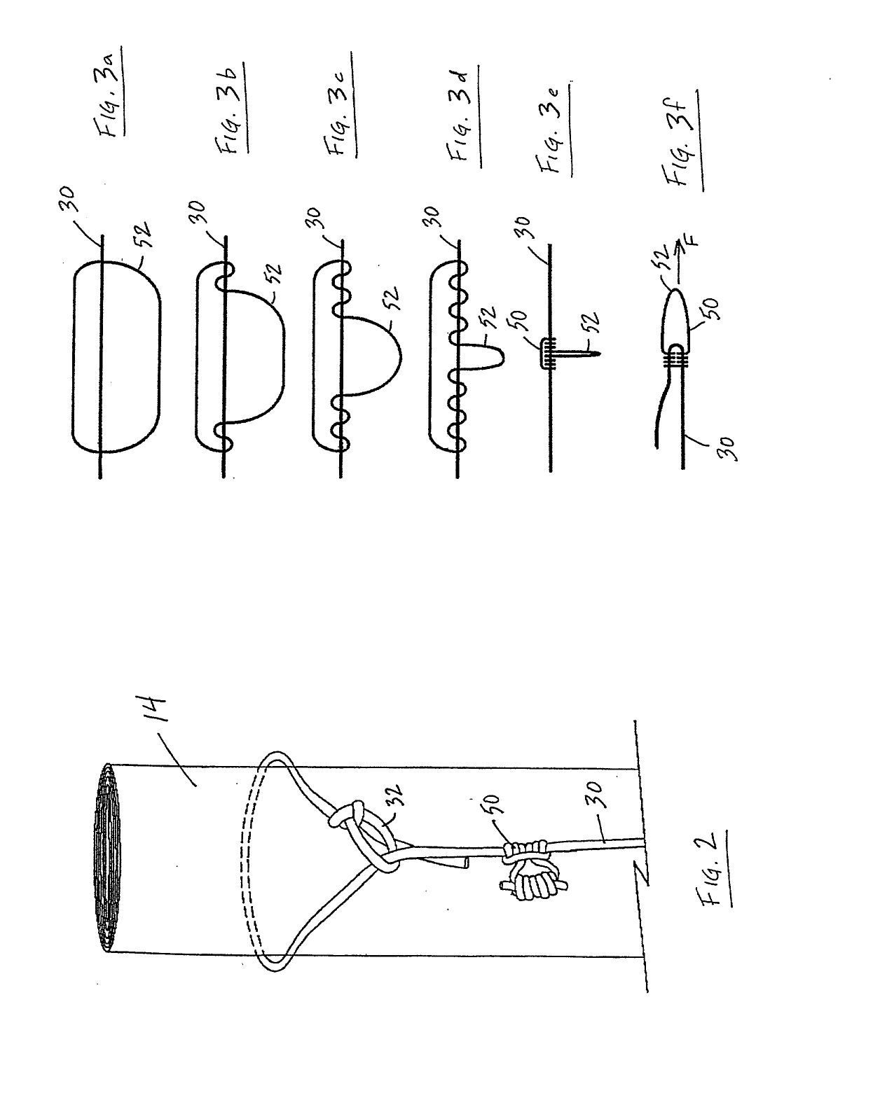

FIGS. 3a-3f schematically demonstrate the tying of a Prusik knot. A loop 52 is formed of a smaller diameter rope than the standing line 30. A bight of the loop 52 is placed over the standing line 30, as shown in FIG. 3a. The loop 52 is wrapped once around the standing line 30 as shown in FIG. 3b, wrapped again around the standing line 30 as shown in FIG. 3c, and wrapped a third time around the standing line 30 as shown in FIG. 3d. The loop 52 is pulled to tighten and tidy the coils of the knot, as shown in FIG. 3e, to form the sliding loop 50. The sliding loop 50 slides freely along the standing line 30 in the unloaded configuration shown in FIG. 3e. When a load F is applied to the loop 52 of the sliding loop 50, however, the sliding loop tightens as shown in FIG. 3f, and resists movement along the standing line 30.

The present invention also comprises a safety system for preventing or minimizing injury from a fall. The safety system of the present invention preferably comprises a standing line 30 and sliding loop 50, substantially as described above, in combination with a safety harness 16, and coupling means for attaching the sliding loop 50 to the safety harness 16. In preferred form, the coupling means is a releasable coupler such as a carabiner 60.

The safety line and system of the present invention enable a method of preventing or minimizing injury due to a fall from an elevated position. With reference to FIG. 1, a standing line 30 is secured to a support structure adjacent the elevated position. This can be accomplished, for example, by tying a fixed loop 32 in the standing line 30, wrapping the standing line around a tree 14 or other overhead support structure, passing the free end of the standing line through the fixed loop 32, and tightening the standing line around the tree at or above the expected head level of the user. A sliding loop 50 is slidably connected to the standing line 30, whereby the sliding loop is freely movable along the standing line when not under load, but resists movement relative to the standing line when under load. This can be accomplished, for example, by tying a prusik knot in a loop of rope around the standing line, as described above. The sliding loop 50 is coupled to the user 10, for example by coupling the sliding loop to a harness worn by the user, as by a carabiner. The position of the sliding loop 50 is adjusted along the standing line 30 to a position as high as will permit the user the necessary freedom of movement. In this manner, the effective length of the safety line (i.e., the maximum permitted distance between the user and the support structure) is minimized, and in the event of a fall the distance fallen will be minimized. If greater freedom of movement is necessary, for example if the user wishes to sit down on the treestand or needs to reach equipment lying on the treestand, the position of the sliding loop 50 can be adjusted downwardly along the standing line 30, thereby increasing the effective length of the safety line. In the event of a fall, the user's weight applies a load to the sliding loop 50, which then resists movement along the standing line 30 to arrest the fall.

The safety line of the present invention provides several additional benefits. For example, the safety line can be configured to serve as a lineman's belt or climbing belt to assist in ascending and descending a tree or pole. The fixed loop 32 of the standing line is secured to a first D-ring with carabiner or other connection point of the harness 16. The user faces the tree or pole and the free end of the standing line and the sliding loop 50 are wrapped around the tree or pole. The loop 52 of the sliding loop 50 is secured to a second D-ring with carabiner or other connection point of the harness, and the position of the sliding loop along the standing line is adjusted to a length that permits the user to lean back, away from the tree or pole, and use his or her feet to climb or descend lineman style. The user's weight applies load to prevent the sliding loop 50 from moving along the standing line 30. The user may adjust the length of the belt by repositioning the sliding loop along the standing line. For example, it may be desirable to shorten the length of a lineman's belt as the user ascends toward the top of a tree where the tree's diameter is smaller. The safety line can also be used as a deer drag to assist the user in dragging a deer. Adjustment of the position of the sliding loop 50 along the standing line 30 permits the effective length of the deer drag to be varied to raise the deer's head to prevent antlers from dragging on the ground.

While the invention has been described in its preferred forms, it will be readily apparent to those of ordinary skill in the art that many additions, modifications and deletions can be made thereto without departing from the spirit and scope of the invention.

What is claimed is:

1. A safety line comprising:
a standing line comprising means for attachment to a support structure; and
a sliding loop connected to said standing line and slidable along at least a portion of the length of said standing line, wherein said sliding loop is freely movable along said standing line when not loaded, but resists movement relative to said standing line when under load.

2. The safety line of claim 1, wherein said means for attachment to a support structure comprises a looped portion of said standing line.

3. The safety line of claim 1, wherein said means for attachment to a support structure comprises a clip attached to said standing line.

4. The safety line of claim 1, wherein said sliding loop comprises a knotted length of rope.

5. The safety line of claim 4, wherein said knotted length of rope has a smaller diameter than said standing line.

6. The safety line of claim 1, wherein said sliding loop comprises a prusik hitch.

7. The safety line of claim 1, further comprising coupling means for attaching said sliding loop to a user.

8. The safety line of claim 7, wherein said coupling means comprises a carabiner.

9. A safety system for preventing injury from a fall, comprising:
a safety harness for engaging a wearer;
a standing line for attachment to a support structure;
a sliding loop slidable along at least a portion of the length of said standing line, wherein said sliding loop is freely movable along said standing line when not loaded, but resists movement relative to said standing line when under load; and
coupling means for attaching said sliding loop to said safety harness.

10. The safety system of claim 9, wherein said standing line comprises a looped portion.

11. The safety system of claim 9, wherein said standing line comprises a clip.

12. The safety system of claim 9, wherein said sliding loop comprises a knotted length of rope.

13. The safety system of claim 12, wherein said knotted length of rope has a smaller diameter than said standing line.

14. The safety system of claim 9, wherein said sliding loop comprises a prusik hitch.

15. The safety system of claim 9, wherein said coupling means comprises a carabiner.

16. The safety system of claim 9, wherein said safety harness comprises a belt.

17. The safety system of claim 9, wherein said safety harness comprises a multi-point body harness.

18. A method for preventing injury due to a fall from an elevated position, said method comprising the steps of:
securing a standing line to a support structure adjacent the elevated position;
slidably connecting a sliding loop to the standing line, whereby the sliding loop is freely movable along the standing line when not loaded, but resists movement relative to the standing line when under load; and
coupling the sliding loop to a user.

19. The method of claim 18, wherein the step of slidably connecting a sliding loop to the standing line comprises tying a prusik hitch.

20. The method of claim 18, wherein the step of coupling the sliding loop to a user comprises coupling the sliding loop to a harness worn by the user.
